(19) United States
(12) Patent Application Publication
(10) Pub. No.: US 2018/0126387 A1
(43) Pub. Date: May 10, 2018

(54) A COMMINUTING MACHINE COMPRISING A ROTOR SYSTEM AND A METHOD FOR COMMINUTING FEEDSTOCK

(71) Applicant: B. MAIER ZERKLEINERUNGSTECHNIK GMBH, Bielefeld (DE)

(72) Inventor: Stefan REIMANN, Bielefeld (DE)

(73) Assignee: B. MAIER ZERKLEINERUNGSTECHNIK GMBH, Bielefeld (DE)

(21) Appl. No.: 15/571,471

(22) PCT Filed: May 4, 2016
(86) PCT No.: PCT/DE2016/000188

§ 371 Date: Nov. 2, 2017

(30) Foreign Application Priority Data
May 5, 2015 (DE) 10 2015 005 642.5

(51) Int. Cl. B02C 18/22; B02C 18/14; B27L 11/00

(52) U.S. Cl. CPC B02C 18/2291; B27L 11/005; B02C 18/144

(57) ABSTRACT

The invention relates to a comminuting machine (8) with a rotor system, in particular a knife ring flaker, in which the feedstock is conveyed pneumatically in the axial direction into the central region of the rotor (10) and is conveyed in the radial direction to the comminuting tools arranged around the rotor (10) in the manner of a ring. In order to uniformly wear the knives extending in the axial direction in such devices, it is proposed to provide in the central region (14) an insert (15) which is rotatably driven by a motor (22) and which has separate chambers (16, 17) with which the feedstock entering said chambers is dispensed at axially and radially to different regions. This insert (15) can, in particular, be designed as a rotor, which has a plurality of chambers which are especially shaped in the cross-section in the manner of a circular sector.

The invention relates to a comminuting machine with a rotor system, in particular a knife ring flaker, in which the feedstock is conveyed pneumatically in the axial direction into the central region of a rotor and is fed in the radial direction to the comminuting tools arranged around the rotor according to claim 1 in the manner of a ring, and to a method for comminuting feedstock according to claim 21.

Wood must be provided in long chips for the production of chipboards or OSB boards. Knife ring flakers such as those known from DE 32 47 629 are used for this purpose.

The wood to be cut is first guided via a feed unit in the form of a wind sifter. The wood or feedstock is passed through a sifting passage in which comparatively heavy particles are separated out. Thus, the wood to be comminuted is pre-cleaned. The transversely directed air stream, which causes the sifting, simultaneously serves as a conveying force, which conveys the feedstock into the comminution chamber of the comminuting machine.

The feedstock hits a rotor there and is deflected by the latter in the radial direction and passes a knife ring, which concentrically surrounds the rotor. On the knives of the knife ring, the feedstock is processed to the desired long chips.

It is a known problem that the feedstock deflected in the radial direction always strikes the knives of the knife ring in the same relatively limited range so that they wear off more strongly in this limited region, while the knives are scarcely worn in adjacent regions of the knife ring flaker.

In order to solve this problem, it is proposed, for example, in the printed publication DE 198 48 233 to deflect the pneumatically supplied feedstock in the radial direction by means of a plurality of impact discs which are arranged staggered axially one behind the other in each case in order to distribute the feedstock evenly over the entire axially available region.

On account of the staggered arrangement of the impact discs, however, the problem arises that the feedstock which flows in axially can cross trajectories of feedstock which has already been deflected in the radial direction, which can thus cause collisions of individual wood parts, causing respectively problems for the disturbance-free operation of a respective comminuting machine.

In order to avoid this problem, it is particularly proposed in the aforementioned state of the art to form the input surface of the central region in a rectangular shape. Thus, an inlet opening is provided with a comparatively small height but with a width over the entire internal diameter of the rotor.

However, this construction comes with the disadvantage that the flow cross-section through which the feedstock is pneumatically conveyed is limited to a considerable extent. This also limits the possible throughput quantity of feedstock accordingly.

In addition, this solution ignores the fact that there is no absolutely even distribution of the incoming feedstock over the width of the resulting inlet opening. On the contrary, it is to be expected that the distribution profile of the feedstock flow has a maximum in the central region and relative minima in the lateral regions. In this way, the impact discs, which are essentially centred in the width in the axial direction at the front, are thus subjected to a greater amount of feedstock than the impact discs located further in the axial direction at the back and in the width direction essentially at the outside. Accordingly, increased wear will occur on the blades in the region at the front in the inflow direction, while the knives wear less in the region which is at the rear in the direction of the inflow.

A uniform wear distribution as desired is thus not guaranteed.

A further form of an insert is known, for example, from DE 26 01 384. However, the subject matter of this older printed publication cannot be applied to the subject matter of the present application because of the fundamentally different manner of conveying the feedstock into the comminution space. While in this known apparatus the feedstock to be comminuted is fed via a chute with which the feedstock is conducted in a controlled manner at low speed and into a comminution chamber at a predetermined location, a pneumatic feed with the aid of an air flow at a corresponding speed is to be assumed in the presently discussed invention, so that the feedstock arrives with high kinetic energy in the comminution chamber, is accommodated there and can then be fed to the comminuting tools in a purposeful manner in a radial direction. In addition, this apparatus has the disadvantage that the incoming material is always supplied to the comminuting tools in the lower region of the comminuting machine, but not over the complete circumference of the comminuting machine. The wear is significantly higher in certain areas of the comminuting machine into which the material is delivered than the other areas, in particular in the lower region. A uniform wear distribution as desired is thus not guaranteed.

It is therefore an object of the present invention to further develop a comminuting machine having a rotor system, in particular a knife ring flaker as described above, as well as a method for comminuting feedstock in a comminuting machine in such a way that the problems explained are reduced and in particular a better distribution of the feedstock in the rotor is enabled.

This object is achieved according to the invention for the comminuting machine in such a way that an insert is arranged in the central region of the rotor into which the feedstock is pneumatically conveyed in the axial direction and can be rotatably driven by a motor and which completely assigns the usually vertically disposed input surface of the central region to chambers disposed directly behind said input surface, which each discharge the feedstock entering them to axially different regions in the radial direction.

The invention has the advantage that the insert can be designed such that it covers the entire vertical input surface of the central region. A design of the input surface with a substantially rectangular shape can thus be avoided and the overall available area for the incoming feedstock can thus be selected to be larger. In particular, this also dispenses with a type of screen which impedes the flow of the material flow.

Due to the arrangement of separate chambers, which are characterized for example by side walls which extend in particular in the radial direction, it can also be prevented that already deflected feedstock collides with the incoming feedstock. The operational reliability of the device is increased in this way.

In addition, the design with chambers, in particular by the side walls, offers the advantage that this creates a driving effect. The material entering the chambers is at least partly entrained in a portion of them. The material entering is entrained by the insert with its chambers from regions with a high volume of material into areas with a lower material volume and thus is fed uniformly to the comminuting tools.

The insert should be decoupled from the other components of the comminuting machine, such as the rotor or the comminuting tools. This decoupling from the comminuting machine is produced, in particular, by the motor driving it, since the insert can be operated independently and thus independently of the rotation of the rotor and/or the comminuting tools.

As a result of the design of the access openings to the chambers, which lie in the vertical inlet surface of the central region, the quantity of feedstock conducted through the individual chambers can also be determined. This can also influence the distribution of the material to be measured over the axial length of the knives.

Preferably, the feedstock entering the insert is also dispensed in radially different regions.

In the context of the present invention, the term “design” is, in particular, the size and shape of the access openings. In particular, it is proposed to design the access opening as circular sectors, preferably as a quadrant, since a particularly even division of feedstock onto the chambers can thus be achieved.

The outlet openings of the chambers provided on the insert are preferably located in the radial direction on the jacket surface defining the insert in the circumferential direction. In particular, however, this outlet opening can also be arranged in the axial direction, in particular in the chamber(s) which are intended to bring the feedstock into the region lying furthest in the front direction, whereby the insert can have a smaller overall length. This not only brings about a reduced installation space for the insert, but also offers the advantage in particular that the insert as such can be smaller.

This is particularly advantageous when the insert is rotatable, since this reduces the inertial mass which is to be accelerated and moved during a corresponding rotation. The insert should, in particular, be formed independently and decoupled from the further components of the system. A coupling of the insert to the knife ring or the rotor would not be advantageous, since this would not achieve an even distribution of the feedstock in the comminuting machine.

In an alternative embodiment, however, it is also possible to make the insert rotate by means of the stream which feeds the feedstock. In such a case, the side walls of the chambers or of the insert, which extend substantially in the radial direction, can then be designed in particular in their axial extension in the form of a turbine blade.

Since it is to be expected that the individual particles of the feedstock meet the mentioned side walls of the chambers especially in case of the rotatability of the insert, these side walls can preferably be provided with wear protection. These may be either hard-coated layers or else welded-on or screwed-on protective plates, etc., which may optionally also be interchangeable.

For the shape of the insert, the shape of a truncated cone is proposed in particular. The top surface of this truncated cone then lies in the region of the inlet surface of the central region, whereas the base surface of this truncated cone is arranged further downstream in the direction of flow. The course of the jacket surface of the truncated cone, which expands in the direction of flow, especially enables a more uniform conveying of the feedstock than would be expected, for example, in the case of a cylindrical shape of the insert.

In a preferred embodiment, it has been found that an external air opening in the flow direction of the pneumatically conveyed feedstock can be advantageous before use. As a result, a more uniform flow is achieved within the insert and the chambers present in the latter, which results in the desired evening out of the feedstock distribution in the rotor.

A further advantageous embodiment provides that the insert is arranged outside the axis of the rotor and/or at an angle to the input surface of the central region. The angle to the input surface of the central region can be seen both horizontally and vertically with respect to the input surface of the central region. The arrangement of the insert relative to the input surface can be stationary or can preferably move together with the rotation of the insert.

Alternatively or in combination with the aforementioned embodiments, the chambers may have different geometries and/or different axial depths. The size of the chambers as well as the size and arrangement of the access and outlet openings from the chambers are included in the geometry. Differently large circular sectors as well as different axial depths can further improve the distribution of the feedstock in the rotor. A targeted control of the material flow can be achieved by a change in the access and outlet openings of the insert, which change is adjusted to the material flow or can also be variable. The outlet openings can also be arranged at different axial depths.

Furthermore, it is possible to arrange the side walls of the chambers or of the insert at an angle to the perpendicular on the radial direction of the insert. By means of these inclined side walls, an improved absorption of the feedstock or of the material flow in the rotor is achieved.

The side walls of the chambers or the insert can alternatively or in combination also be designed in a curved manner, in particular also with respect to their axial extension and/or perpendicularly thereto. For example, they can be designed similarly to a turbine blade.

In an advantageous embodiment, the insert, optionally with its motor, is integrated in the door of the comminuting machine. This in turn allows existing machines to be retrofitted with such a device. On the other hand, the accessibility of the interior of the comminuting machine is also ensured.

Preferably, one or more drivers can be arranged in the chambers. The driver(s), which is or are arranged between the two side walls of a chamber, preferably centrally, can be formed similar to the side walls with respect to their design, wherein their axial length is less than the radius of the insert. Through the drivers, the feedstock is given a further impulse, which further optimizes the distribution of the feedstock in the comminuting machine. Preferably, the drivers are provided with a wear-protection element.

Alternatively, guide elements are arranged in or on the insert, preferably on the jacket surface and/or the bottom surface, which guide elements can specifically guide the feedstock or the material flow both inside and outside the insert. By means of the targeted arrangement of guide elements, the material flow or the feedstock can be distributed or guided more advantageously and in a more material-friendly manner. The material quality and shape of the feedstock is thus maintained to the highest extent until the contact with the comminuting tools.

Preferably, the guide elements are arranged outside the chambers. This can also reduce the influence of air flows on the material flow within the comminuting machine among other things and the material flow can be fed to the comminuting tools almost without influence. In addition, the guide elements can also serve to prevent wear.

Alternatively or in combination, the rotational speed of the insert can be controlled or regulated via a control device, in particular as a function of the material flow. The rotational speed can always be adapted to an optimum operating point which supplies the desired distribution of the feedstock.

Preferably, the speed of the insert is independent of the speed of the knife ring and/or of the rotor, preferably less than the speed of the knife ring and/or of the rotor, in order to achieve an optimum distribution of the feedstock over the complete comminuting machine.

Furthermore, the wear protection can have a geometry deviating from the side surface.

The wear protection can, for example, have a sawtooth-like geometry. Due to the special geometry, the material flow or the feedstock in the chambers can be further influenced and improved. The geometry of the wear protection can also vary depending on the material applied. By adapting the wear protection to the feedstock or the material flow and the exchange of the wear-protection element in the comminuting machine adapted therefor, an improved distribution and comminution of the feedstock can be achieved.

As a further solution, a method for comminuting feedstock is specified, wherein, in the central region of the comminuting machine, an insert assigns separate chambers to the entering feedstock, wherein the insert is rotatably driven by a motor and delivers the feedstock in axially and radially different regions.

The insert forms an independent unit within the comminuting machine, which is decoupled from the further components such as rotor or comminuting tools.

Preferably, the feedstock in the insert is deflected from its original movement and is subjected to acceleration. Through the insert and its movement, a driving effect is produced which moves the feedstock out of its original, rather falling movement and thus ensures an even distribution within the comminuting machine.

In a further embodiment, the feedstock is accelerated in the insert at least partially against the gravitational force and is thus fed more intensively into areas of the comminuting machine which would be exposed to a low flow of material without the insert.

Alternatively or in combination, the rotational speed of the insert is regulated or controlled, in particular as a function of the material flow. In addition to the distribution of the material flow into the chambers and in the comminuting machine, the power requirement for the material flow can also be adjusted and optimized.

It is within the scope of the invention in this case that the insert rotates at a speed independent of the speed of the knife ring and/or of the rotor, preferably with a speed which is lower than the speed of the knife ring and/or of the rotor.

Further advantageous measures and embodiments of the subject matter of the invention are apparent from the subclaims and the following description with the drawings. The following presentations are not to be regarded directly as individual case solutions, but contain in parts also general indications and problem solutions. Individual sentences can be seen in this case as individual features.

The drawings show as follows:

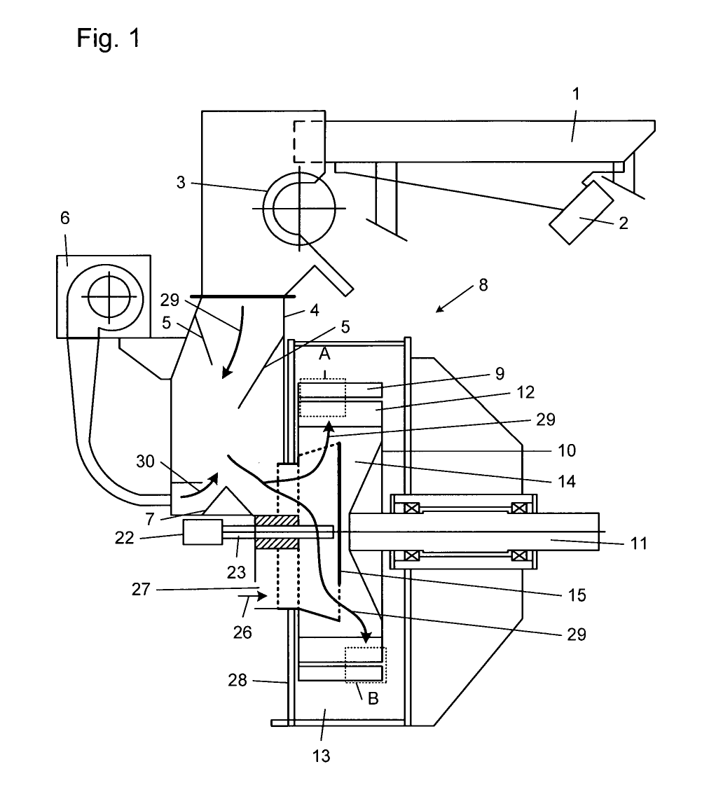

FIG. 1 shows a sectional view of a comminuting machine with an upstream heavy material separator,

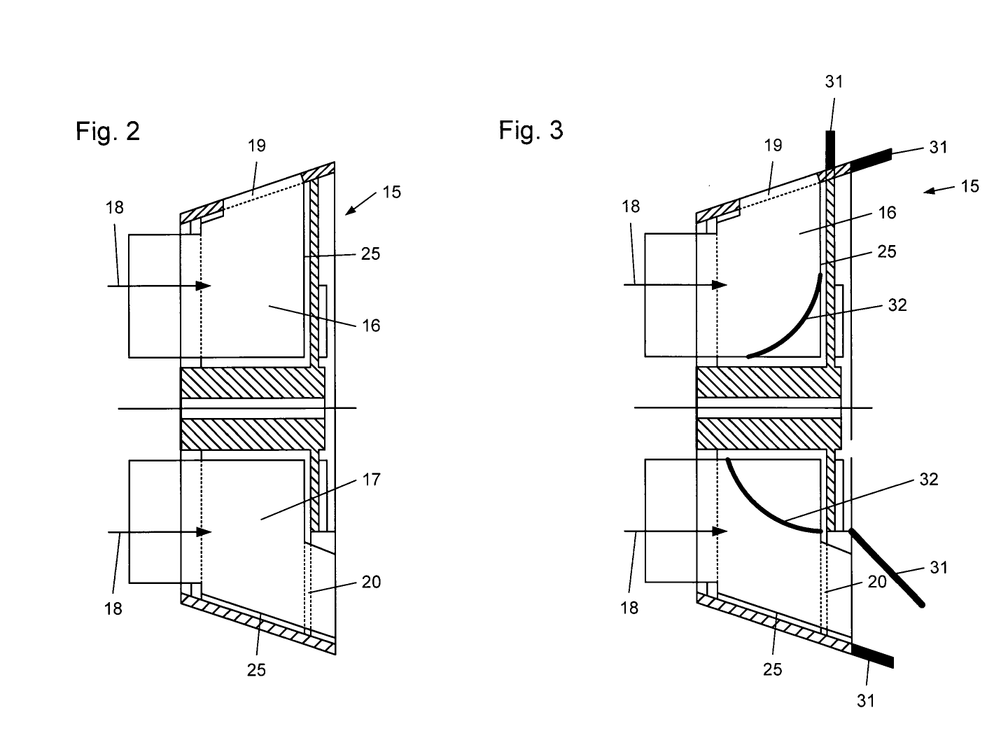

FIG. 2 shows an insert with separate chambers in the sectional view,

FIG. 3 shows a further embodiment of an insert in the sectional view;

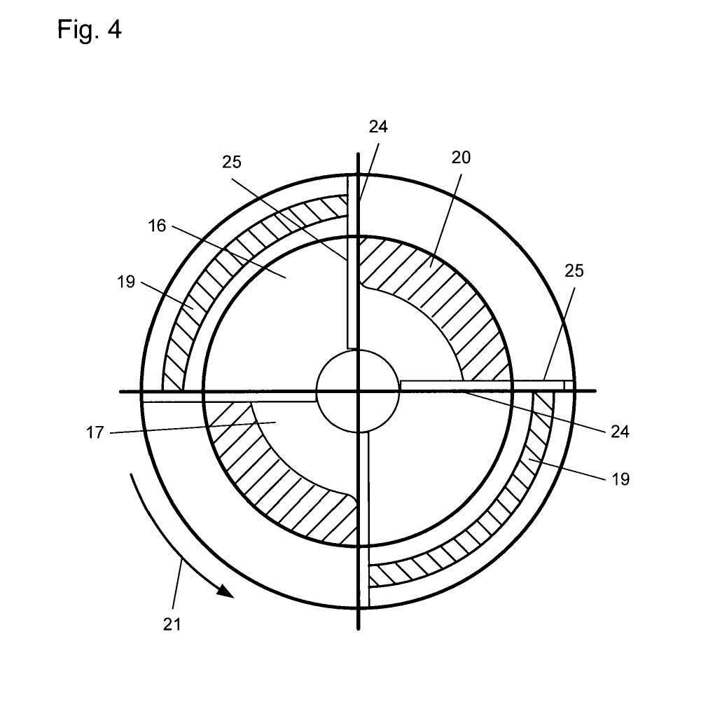

FIG. 4 shows an insert in top view, and

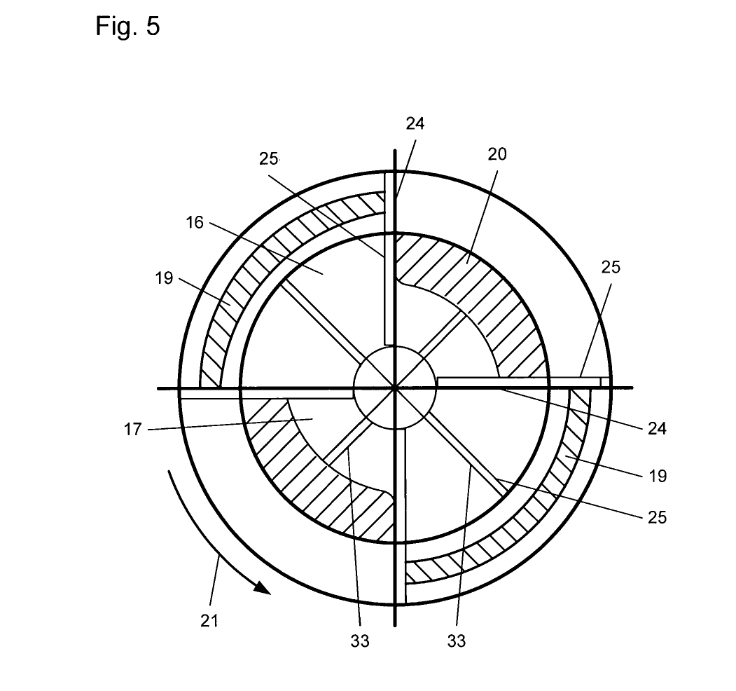

FIG. 5 shows a further embodiment of an insert in the top view.

FIG. 1 shows a comminuting machine 8 according to the invention with an upstream heavy material separator 4. Material or feedstock to be comminuted, in particular coarser wood parts, is fed onto a vibrating channel 1 and conveyed by the latter by means of an unbalanced motor 2. The material is guided in this case via a magnetic roller 3, with which ferromagnetic contaminants are separated from the material falling from the vibrating channel 1.

The material flow 29 falls into a heavy material separator 4, where it is guided in a cascade-like fashion via pivotable guide plates 5.

By means of a blower 6, an air stream 30 is blown from below at the side into the heavy material separator 4 at a speed of about 15 to 20 m/s and is diverted via a guide plate 7 in such a way that feedstock falling from the guide plates 5 onto the guide plate 7 is blown upwards along the guide plate 7. The speed of the air stream 30 is adjusted in this case in such a way that, depending on the specific weight, impurities such as stones or the like cannot be moved upwards by the air stream 30 along the guide plate 7, but instead drop downwards out of the heavy material separator 4.

The feedstock detected by the laterally inflowing air stream 30 is blown or transported into the actual comminuting machine 8.

This comminuting machine 8 has externally a knife ring 9 which has a plurality of radially inwardly extending blades, the cutting edges of which extend in the axial direction. The knife ring 9 can either be fixed or be rotated about its central axis by a corresponding drive.

A rotor 10, which is set in rotation via a shaft 11, is arranged coaxially with this knife ring 9. Optionally, the rotational direction of this rotor 10 is preferably counter to the direction of rotation of the knife ring 9.

Radially on the outside, this rotor 10 has rotor blades 12 which extend parallel to the knives of the knife ring 9 and pass close to these knives so that the feedstock moved past the blades of the rotor blades is shaved. The shavings are removed from the comminuting machine 8 by a discharge chute 13 arranged below the knife ring 9.

In the example shown here, an insert 15 in the form of a distributor rotor sits in the central region 14 of the rotor 10. This distributor rotor is shown separately in FIGS. 2 to 5. It essentially has the shape of a truncated cone but can also be designed in a different way.

It can be seen that the insert 15 has several separate chambers 16, 17. Feedstock enters said chambers in a respective axial-parallel manner from the direction 18 through the access openings arranged on the top surface of the insert 15.

While the feedstock, in the chamber 16 shown in FIGS. 2 and 3 above, is discharged in the radial direction via a side opening 19 located on the conically extending peripheral surface of the insert 15 from the chamber 16 out of the insert 15, the feedstock entering the chamber 17 is discharged through a bottom opening 20 with an axial component, said bottom opening being located on the end face of the insert 15 forming the base area of the insert 15.

In this way, as shown in FIG. 1, the portion of the material flow 29 guided through the chamber 16 is guided in an axially front area A onto the rotor and thus onto the knife ring 9, while the portion of the material flow guided through the chamber 17 is guided to an axially rear region B onto the rotor 10 and thus onto the knives of the knife ring 9.

Through the arrangement of the side opening 19 or the bottom opening 20, it is in particular also ensured that the feedstock emerging from the insert 15 or the emerging material flow 29 precisely hits the rotor 10 in the regions provided which are assigned to them.

In addition, as shown in FIG. 3, guide elements 31, 32 can be arranged in or on the insert 15 in order to be able to selectively guide the incoming and outgoing material. The guide elements 32 arranged in the insert 15 give the material an additional impulse in the direction of the side opening 19 or the bottom opening 20. The shape of the guide elements 32 can be straight or curved. Furthermore, these can also be arranged in sections. The guide elements 31 arranged on and thus outside the insert 15 serve, on the one hand, to guide the material to the comminuting tools, here the knives of the knife ring 9, into the region A, B. On the other hand, these guide elements 31 can influence the swirling onto the feedstock after exiting from the side opening 19 and the bottom opening 20. Furthermore, the guide elements 31 can additionally be used for wear protection, such as, for example, the guide element 31 arranged behind a bottom opening 20, as shown in FIG. 3. This guide element 31 prevents the material emerging from the insert 15 from being guided to the rear wall of the comminuting machine 8, but rather is directed in the region B towards the comminuting tools. The arranged guide elements 31, 32 can all be realized individually or in any combination with one another.

In the exemplary embodiment illustrated here, it is provided that the distributor rotor has a total of four chambers, each forming a quadrant of the frustoconical insert 15. In the example illustrated here, chambers 16, 17, which have side openings 19 on the circumferential surface of insert 15, and such which have bottom openings 20 on the front or bottom surface of insert 15, thus alternate in the circumferential direction.

In principle, it is also possible to divide the insert 15, for example, into six or more chambers 16, 17 which essentially cover circular sectors. These chambers 16, 17 each have assigned side openings corresponding to different axial depths in the jacket surface of the distributor rotor. This is accompanied by an even greater equalization of the feedstock distribution in the axial direction of the comminuting machine 8.

As a result, the knives of the knife ring 9 are uniformly loaded over their length and therefore wear off evenly.

An essential aspect is that the insert 15 rotates, as shown in FIGS. 4 and 5 by the direction of rotation 21. This rotation is preferably in the same direction as the direction of rotation of the rotor 10. The insert 15 is thereby driven by a motor 22 via a shaft 23. This leads to the fact on the one hand that the material flow 29 guided through the insert 15 is directed outwards in the radial direction and, on the other hand, the material flow 29 is distributed in the circumferential direction via the rotor 10 or via the knife ring 9 by the rotary movement of the insert 15 in the direction of rotation 21. As a result, the wear of the blades of the knife ring 9 is thus further provided in a more uniform manner.

Since, as a result of the rotation of the insert 15, the individual particles of the feedstock impact the side walls 24 of the chambers 16 and 17, they are provided with flat wear-protection elements 25 which are screwed on in the present case. Should these wear-protection elements 25 be worn, they can be replaced so that the service life of the device is correspondingly prolonged.

Furthermore, it can be advantageous that one or more drivers 33 are arranged within the insert 15 or a chamber 16, 17. The drivers 33 additionally exert an impulse on the feedstock and thereby improve the distribution of the material flow in the comminuting machine 8. The drivers 33 preferably have a length expansion which does not extend as far as the circumferential surface of the insert 15. Furthermore, the size of the access opening into the chamber 16, 17 is not reduced by the drivers 33, as would be the case with the use of an insert with a larger number of chambers 16, 17. These drivers 33 can additionally comprise a wear-protection element 25.

It has been found that it is advantageous to optionally enrich the material flow 29, when entering the insert 15, with external air 26 from external air openings 27 arranged in front of the insert 15. In this way, it is to be prevented that unwanted sub-pressures or fluid-technical dead spaces form within the rotating insert 15, in which feedstock can accumulate. Thus, the distribution of the feedstock along the axial length of the rotor 10 is improved by this external air 26.

It should also be mentioned that the insert 15 proposed here, with its motor 22, etc., can also be mounted on a door 28 which carries it. Thus, comminuting machines 8, which optionally may be comparable in their basic concept, can be retrofitted with a corresponding rotatable insert 15.

List of reference numerals P0183WO

| | |
|---|---|
| 1 | Vibrating channel |
| 2 | Unbalanced motor |
| 3 | Magnetic roller |
| 4 | Heavy material separator |
| 5 | Guide plate |
| 6 | Blower |
| 7 | Guide plate |
| 8 | Comminuting machine |
| 9 | Knife ring |
| 10 | Rotor |
| 11 | Shaft |
| 12 | Rotor blade |
| 13 | Discharge chute |
| 14 | Central region |
| 15 | Insert |
| 16 | Chamber |
| 17 | Chamber |
| 18 | Direction |
| 19 | Side opening |
| 20 | Bottom opening |
| 21 | Direction of rotation |
| 22 | Motor |
| 23 | Shaft |
| 24 | Side walls |
| 25 | Wear-protection elements |
| 26 | External air |
| 27 | External air opening |
| 28 | Door |
| 29 | Material flow |
| 30 | Air stream |
| 31 | Guide element |
| 32 | Guide element |
| 33 | Driver |
| A | Region |
| B | Region |

1. A comminuting machine comprising a rotor system in which feedstock is conveyed pneumatically in an axial direction into a central region of a rotor and is fed to comminuting tools which are arranged in a radial direction around the rotor in a form of a ring, wherein an insert is arranged in a central region, which is rotatably driven by a motor and which assigns an input surface of the central region to separate chambers, which each discharge the feedstock entering them to axially different regions.

2. The comminuting machine according to claim 1, wherein the insert covers an entire essentially vertically situated input surface of the central region.

3. The comminuting machine according to claim 1, wherein the separate chambers have side walls extending in the radial direction.

4. The comminuting machine according to claim 1, wherein the chambers have access openings having the form of circular sectors.

5. The comminuting machine according to claim 1, wherein the insert has chambers with outlet openings which are arranged on a jacket surface which delimits the insert in a circumferential direction.

6. The comminuting machine according to claim 1, wherein the insert has chambers with outlet openings which are arranged on a bottom which delimits the insert in the axial direction.

7. The comminuting machine according to claim 1, wherein the chambers have side walls which are provided with a wear-protection element.

8. The comminuting machine claim 1, further comprising an external air opening arranged upstream of the insert in a flow direction of the pneumatically conveyed feedstock.

9. The comminuting machine according to claim 1, wherein the insert is arranged outside an axis of the rotor and/or obliquely with respect to the input surface of the central region.

10. The comminuting machine according to claim 1, wherein the chambers have different geometries and/or different axial depths.

11. The comminuting machine according to claim 3, wherein the side walls are arranged at an angle to a perpendicular on the radial direction of the insert.

12. The comminuting machine according to claim 3, wherein the side walls are bent in the radial direction and/or perpendicularly thereto.

13. The comminuting machine according to claim 1, wherein the insert is integrated in a door of the comminuting machine.

14. The comminuting machine according to claim 1, further comprising drivers arranged in the chambers.

15. The comminuting machine according to claim 14, wherein the drivers are provided with a wear-protection element.

16. The comminuting machine according to claim 1, further comprising guide elements arranged in or on the insert, on a jacket surface and/or a bottom surface.

17. The comminuting machine according to claim 16, wherein a guide element is arranged outside the chambers.

18. The comminuting machine according to claim 1, wherein a rotational speed of the insert is configured to be controlled or regulated via a control device depending on a material flow.

19. The comminuting machine according to claim 1, wherein a rotational speed of the insert is independent of a rotational speed of a knife ring and/or the rotational speed of the rotor, and is lower than the rotational speed of the knife ring and/or the rotational speed of the rotor.

20. The comminuting machine according to claim 7, wherein the wear protection has a geometry which deviates from the side walls.

21. A method for comminuting feedstock in a comminuting machine, the method comprising:
pneumatically conveying feedstock in an axial direction into a central region of a rotor;
supplying the feedstock to comminuting tools arranged in a radial direction around the rotor in the manner of a ring, and
assigning, in a central region of the comminuting machine, incoming feedstock to separate chambers via an insert, wherein the insert is rotatably driven by a separate motor and delivers the feedstock into axially and radially different regions.

22. The method according to claim 21, wherein the feedstock in the insert is deflected from its original movement and undergoes an acceleration.

23. The method according to claim 22, wherein the feedstock in the insert is at least partially accelerated counter to gravity.

24. The method according to claim 21, wherein a rotational speed of the insert is regulated or controlled depending on a material flow.

25. The method according to claim 21, wherein the insert rotates at a rotational speed which is independent of a rotational speed of a knife ring and/or a rotational speed of the rotor, and is lower than the rotational speed of the knife ring and/or the rotational speed of the rotor.
